(19) United States
(12) Patent Application Publication
(10) Pub. No.: US 2007/0136042 A1
(43) Pub. Date: Jun. 14, 2007

(54) Quadrilateral grid extension of central difference scheme for ink-jet simulations

(76) Inventor: Jiun-Der Yu, Sunnyvale, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/299,065

(22) Filed: Dec. 9, 2005

(51) Int. Cl. G06G 7/48

(52) U.S. Cl. 703/9

(57) ABSTRACT

A central difference scheme, on which a coupled level set projection method is based, is extended to quadrilateral grids on axi-symmetric coordinate systems. The level set projection method is incorporated into a finite-difference-based ink-jet simulation algorithm. The extension involves modification of the Navier-Stokes equations and the level set convection equation. Moreover, the velocity and level set correctors in axi-symmetric coordinate systems should be “recovered” to point values before being projected. Numerical differentiation and integration in the central difference scheme are done in the computational space. The inventive algorithm may be embodied in methods, apparatuses, and instruction sets carried on device-readable mediums.

### RELATED APPLICATION DATA

This application is related to application Ser. No. 10/957,349, filed on Oct. 1, 2004, and entitled; “2D Central Difference Level Set Projection Method for Ink-Jet Simulations”; and application Ser. No. 10/390,239, filed on Mar. 14, 2003, and entitled “Coupled Quadrilateral Grid Level Set Scheme for Piezoelectric Ink-Jet Simulation.” The disclosures of these related applications (referred to below as related application 1 and related application 2 respectively) are incorporated by reference herein in their entirety.

### BACKGROUND OF THE INVENTION

1. Field of the Invention

The present invention relates to an improved model and accompanying algorithm to simulate and analyze ink ejection from a piezoelectric print head. The improvements to the simulation model and algorithm include a further extension of the central difference scheme of related application 1 to a broader range of applications. The simulation model and algorithm may be embodied in software and run on a computer, with the time-elapsed simulation viewed on an accompanying monitor.

2. Description of the Related Art

Related application 2 discloses a coupled level set projection method on a quadrilateral grid. In that invention, the velocity components and level set are located at cell centers while the pressure is at grid points. The Navier-Stokes equations are first solved in each time step without considering the condition of incompressibility. Then, the obtained velocity is “projected” into a space of a divergence-free field. A Godunov upwind scheme on quadrilateral grids is used to evaluate the convection terms in the Navier-Stokes equations and the level set convection equation. A Taylor's expansion in time and space is done to obtain the edge velocities and level sets. Since the extrapolation can be done from the left and right hand sides for a vertical cell edge and can be done from the upper and lower sides for a horizontal edge, there are two extrapolated values at each cell edge (as indicated in equations (50)-(52) of related application 2). Then, the Godunov upwind procedure is employed to decide which extrapolated value to take (as per equations (53) and (54) of related application 2). In the Godunov upwind procedure, a local Riemann problem is actually solved. So basically the local velocity direction decides which extrapolated value to use. The advantage of this kind of upwind scheme for advection terms is lower grid viscosity and higher numerical resolution. Its disadvantage is the increased code complexity needed to do the Taylor's extrapolation in both time and space and Godunov's upwind procedure.

In the two-dimensional central difference scheme disclosed in related application 1, the Navier-Stokes equations are again first solved in each time step without considering the condition of incompressibility. Then, the obtained velocity is “projected” into a space of divergence-free field. However, in contrast to the upwind scheme, the central difference scheme uses staggered cell averages, and the direction of local velocity is not important. The Taylor's extrapolation in time is still used in calculating the time-centered velocity and level set predictors. But since it is only an extrapolation in time, the code implementation is much easier. One characteristic of the scheme is, if at time step t=tⁿ the velocities and level set are located at cell centers, they are located at grid points at the next time step t=tⁿ⁺¹. The velocities and level set will be at cell centers again at time step t=tⁿ⁺². For this reason, the grids are described as being “staggered.” The advantages of a central scheme are (1) easy implementation; (2) lower computer memory requirement; and (3) easier generalization to non-Newtonian flows.

### SUMMARY OF THE INVENTION

The present invention extends the central difference scheme of related application 1, which is for two-dimensional two-phase flow simulations, to quadrilateral grids in axi-symmetric coordinate systems. Accordingly, an improved model and accompanying algorithm to simulate and analyze ink ejection from a piezoelectric print head are provided.

Broadly speaking, the present invention includes a central difference numerical scheme for the coupled level set projection method on quadrilateral grids. The numerical scheme works in axi-symmetric coordinate systems, with the Cartesian coordinate systems being a special degenerate case. The present invention also involves the transformation of body fitted quadrilateral grids in the physical space to uniform square grids in the computational space. The numerical differentiation and integration in the central difference scheme are done in the computational space.

According to one aspect of this invention, a method for simulating and analyzing fluid ejection from a channel is provided. Preferably, the channel comprises an ink-jet nozzle that is part of a piezoelectric ink-jet head. There is a boundary between a first fluid (e.g., ink) that flows through the channel and a second fluid (e.g., air). The method generally comprises transforming, for a given channel geometry, a quadrilateral grid in a physical space to a uniform rectangular grid in a computational space; formulating a central-difference-based discretization on the uniform rectangular grid in the computational space; performing finite difference analysis on the uniform rectangular grid in the computational space using the central-difference-based discretization to solve equations governing the flow of at least the first fluid through at least a portion of the channel; inverse transforming the results of the finite difference analysis back to the quadrilateral grid in the physical space; and simulating the flow of the first fluid through at least the portion of the channel, and ejection therefrom, based on the results of the finite difference analysis.

In another aspect, the invention involves an apparatus for simulating and analyzing fluid ejection from a channel with a boundary between a first fluid that flows through the channel and a second fluid. The apparatus comprises one or more components or modules that is/are configured to perform the processing described above. Some or all of the processing may be conveniently specified by a program of instructions that is embodied in software, hardware, or combination thereof. One of the components preferably includes a display for enabling visual observation of the simulation.

In accordance with further aspects of the invention, various aspects of the invention may be embodied in a program of instructions, which may be in the form of software that may be stored on, or conveyed to, a computer or other processor-controlled device for execution. Alternatively, the program of instructions may be embodied directly in hardware (e.g., application specific integrated circuit (ASIC), digital signal processing circuitry, etc.), or such instructions may be implemented as a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts:

FIG. 1 is a graph of a driving voltage applied to a piezoelectric ink-jet head over one cycle;

FIG. 2 is a graph of dynamic pressure that is applied at the nozzle inflow in the ink-jet simulation over one cycle;

FIG. 3 illustrates a transformation that maps grid points in a computational space, where grid cells are rectangular, to a physical space, where grid cells are quadrilateral;

FIG. 4 is a diagram of an exemplary boundary-fitted quadrilateral grid in the physical space, for ink-jet simulation according to embodiments of the present invention;

FIG. 5 is a diagram of an exemplary uniform square or rectangular grid in the computational space;

FIG. 6 is a schematic diagram of a staggered grid for use in embodiments of the invention;

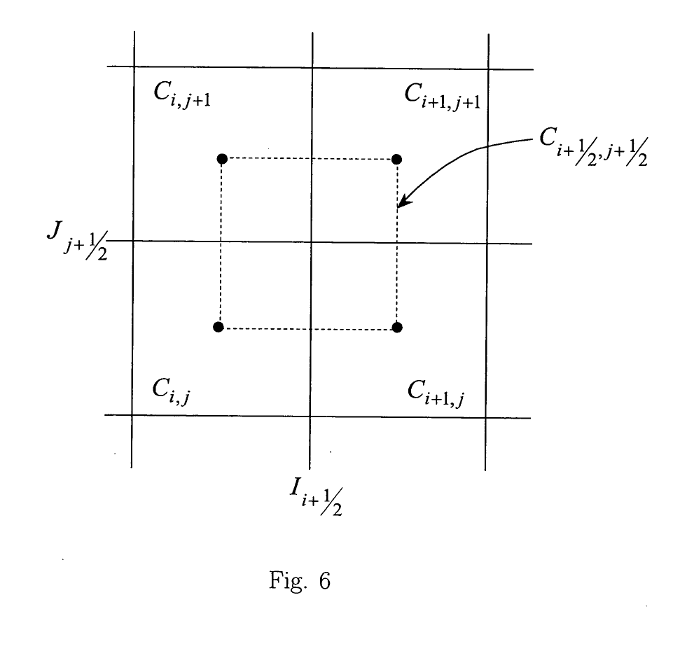

FIG. 7 is a flow chart illustrating method steps and/or functional operations performed according to embodiments of the present invention; and

FIG. 8 is a block diagram illustrating an exemplary system that may be used to implement aspects of the present invention.

### DESCRIPTION OF THE PREFERRED EMBODIMENTS

I. Introduction

In the following detailed description, the governing equations and boundary conditions for ink-jet simulations are first set forth, as well as the transformed governing equations to be used in the computational space. The conservation form is preferred for advection terms, so the Navier-Stokes equations and the level set convection equation are slightly different from those set forth in the second related application. Then, the central difference scheme for two-phase flows on quadrilateral grids is explained. Note that, while in related application 1, the velocity and level set correctors are directly used as the point value and projected, those correctors in ax-symmetric coordinate systems should be “recovered” to point values before being projected.

II. Level Set Formulation

A. Governing Equations

The governing equations for incompressible, immicible, two-phase flows include the continuity equation (1) and the Navier-Stokes equations (2), as set forth in the Appendix along with the other numbered equations, relationships or definitions referenced herein. In these equations, the rate of deformation tensor and the fluid velocity are respectively defined in equations (3). In these equations, ρ is the density, p the pressure, μ the dynamic viscosity, σ the surface tension coefficient, κ the curvature, δ the Dirac delta function, and φ the level set.

A level set formulation is used to define the interface between the two fluids, e.g., ink and air, and hence the density, dynamic viscosity, and curvature are all defined in terms of the level set φ as set forth in equation (4). Here, the level set function φ is initialized as the signed distance to the interface, i.e., the level set value is the shortest distance to the interface on the liquid side and is the negative of the shortest distance on the air side. The unit normal on the interface, drawn from fluid 2 into fluid 1, and the curvature of the interface can be expressed in terms of φ as in equation (5).

To make the governing equations dimensionless, the following definitions, as set forth in (6), are chosen. In those definitions, the primed quantities are dimensionless, and L, U,ρ₁,μ₁ represent the characteristic length, characteristic velocity, density of fluid 1, and dynamic viscosity of fluid 1, respectively. The characteristic velocity and characteristic length can be arbitrarily chosen, as they do not influence the result of simulation.

Substituting the relationships of (6) into equations (1) and (2) and dropping the primes, yields equations (7) and (8), where the relative density ratio ρ(φ), relative viscosity ratio μ(φ), Reynolds number Re, and Weber number We are defined as in (9). Since the interface moves with the fluid, the evolution of the level set is governed by equation (10).

Since equations (5), (7), (8), and (10) are expressed in terms of the vector notation, they assume the same form in Cartesian coordinates and axi-symmetric coordinates. It is also noted that the conservative form for the convection terms in equations (8) and.(10) are used.

B. Governing Equations on Quadrilateral Mesh

In the context of this invention, the interest is in finite difference analysis in reasonably complex geometries, for which a rectangular grid may not work well. Thus, there is a need for a general quadrilateral grid formulation. This can be done by carefully transforming the viscosity and surface tension terms, as disclosed in related application 2.

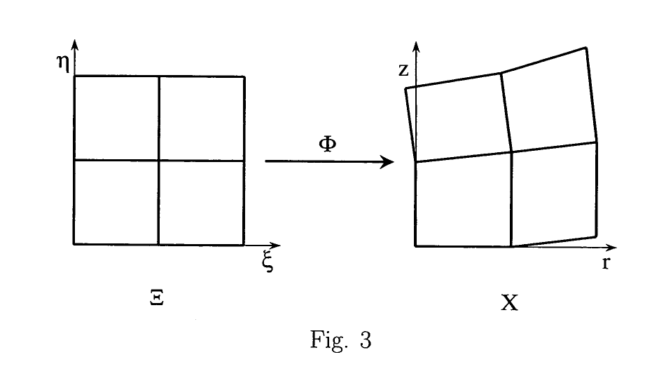

Consider a continuous transformation Φ that maps the grid points in a rectangular computational space Ξ=(ξ,η) to the physical axi-symmetric space X=(r,z) according to equation (11) and as shown in FIG. 3. The Jacobian, which describes how a grid cell changes its volume in the transformation, and the transformation matrix, which describes how a grid cell distorts in the transformation, are defined by (12), where g=2πr for the axi-symmetric coordinate system. For the convenience of future discussion, the transformed convection velocity is defined as in equation (13).

The above definitions for axi-symmetric coordinate systems can be easily extended to the two-dimensional Cartesian system by the substitution shown in (14).

The governing equations in the computational space are as stated in (15), where the viscosity term is as stated in equation (16).

Several observations are in order here. First, the equations in (15) are derived for a quadrilateral grid in the axi-symmetric coordinate system; however, they can be used for two-dimensional flow problems if the last term in equation (16) is neglected and the substitutions in (14) are used. Also, equation (16) can be checked by reducing the computational space Ξ=(ξ,η) to the physical space X=(r,z). For this case, the transformation matrix reduces to the identity matrix and the Jacobian to g. Furthermore, it should be noted that ∇_{Ξ} and ∇_{Ξ}· are “matrix operators” while ∇ and ∇· are vector operators. When a vector operator is put in front of a vector quantity, it not only “operates” on the magnitude of the vector quantity but also on the direction. Here, the matrix operators ∇_{Ξ} and ∇_{Ξ}· are applied to scalars or matrices, and hence the “direction” is not relevant. Finally, due to the use of the conservative form for the Navier-Stokes equations and the level set convection equation, the convection terms in (15) look a little different from those in (29) of related application 2.

C. Boundary Conditions

On solid walls it is assumed that both the normal and tangential components of the velocity vanishes, although this assumption must be modified at the triple point. At both inflow and outflow the formulation herein allows one to prescribe either the velocity (17) or the pressure boundary condition (18). In equation (18), the symbol n denotes the unit normal to the inflow or outflow boundary. For ink-jet simulations, time-dependent inflow conditions are provided by an equivalent circuit model, which mimics the charge-driven mechanism which forces ink from the bath into the nozzle.

D. Contact Models

At the triple point, where air and ink meet at the solid wall, the slipping contact line model as presented in application Ser. No. 10/105,138, filed on Mar. 22, 2002 and entitled “A Slipping Contact Line Model and the Mass-Conservative Level Set Implementation for Ink-Jet Simulation” is used. The disclosure of this application is incorporated herein by reference.

E. Equivalent Circuit

In a piezo electric print head, the formation of the ink droplet is controlled by a piezoelectric PZT actuator. Driven by the input voltage, the PZT pushes and then pulls the ink. To numerically simulate an ink-jet print head, a velocity or pressure at nozzle inflow must be specified. Various appropriate values of these parameters may be specified by the user before simulation, or such values may be the result of previous measurements taken at different voltages input to PZT.

Another analytic tool that may be developed and used to obtain inflow pressures that may be used for simulation of the ink-jet print head is an equivalent circuit. Such an equivalent circuit determines inflow pressure based on input voltage and ink flow rate. For example, the ink flow rate and pressure can be taken as independent variables. Each component of the ink-jet print head, such as the nozzle, pressure chamber, vibration plate, PZT actuator, and ink cartridge is expressed in terms of the acoustics inertance, compliance, and acoustics resistance. These acoustics elements are finally transferred to their equivalent inductance, capacitance, and electric resistance to form an equivalent circuit. By solving the equivalent circuit and the flow equations in term a real ink-jet head can be simulated. Other suitable methods may also be used to obtain inflow pressure values that relate to the PZT input voltage.

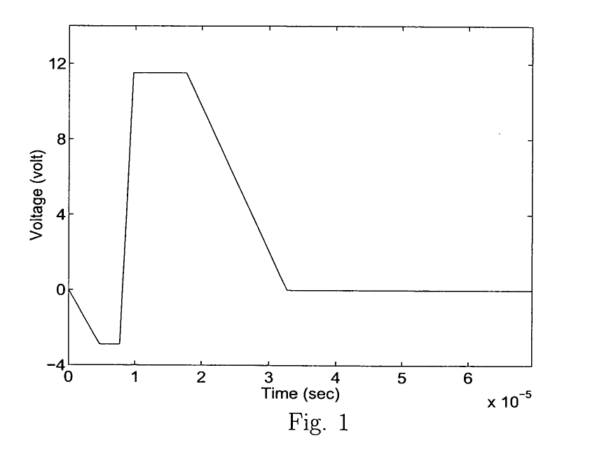

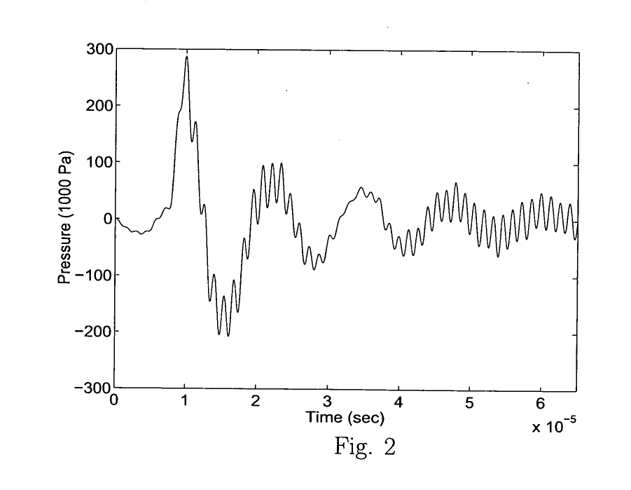

A typical driving voltage pattern and a typical inflow pressure are as shown in FIGS. 1 and 2. The driving voltage is such that the ink is first pulled back, pushed and fired, and then pulled back to get ready for the next discharge. The inflow pressure shown in FIG. 2 reflects the reaction of a typical nozzle-ink channel-PZT-cartridge system to the applied voltage. The pressure pattern contains several high frequency signals. The largest one is basically the fundamental natural frequency of the system, which is five to six times higher than the driving voltage frequency in this case. The small oscillations are probably related to the natural frequencies of the components in the system.

III. The Central Difference Scheme

The numerical algorithm is now formulated on quadrilateral grids in axi-symmetric coordinate systems. In the following, the superscript n (or n+1) denotes the time step, i.e., equation (19), and so on.

Given quantities uⁿ, pⁿ, φⁿ, the purpose of the algorithm is to obtain uⁿ⁺¹, pⁿ⁺¹, φⁿ⁺¹ which satisfy the condition of incompressibility. The explicit algorithm described herein is first-order accurate in time and second-order accurate in space.

A. Smearing of the Interface

Because of the numerical difficulty caused by the Dirac delta function and by the abrupt change of the density and viscosity across the interface, the Heaviside and Dirac delta functions are replaced with smoothed ones, i.e., to smear the interface a little bit. The Heaviside function is redefined as in (20). Hence, the smoothed delta function is as set forth in equation (21).

The parameter ε is usually chosen to be proportional to the average size of cells as set forth in (22), where Δx is the average size of the quadrilateral cells. I usually choose an α between 1.7 and 2.5.

The density and viscosity hence become as set forth in equations (23).

B. The Central Scheme

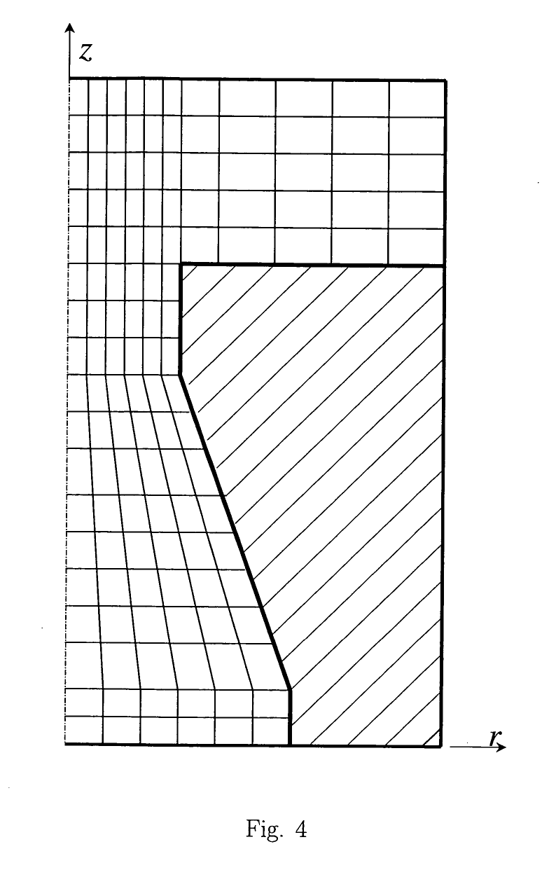

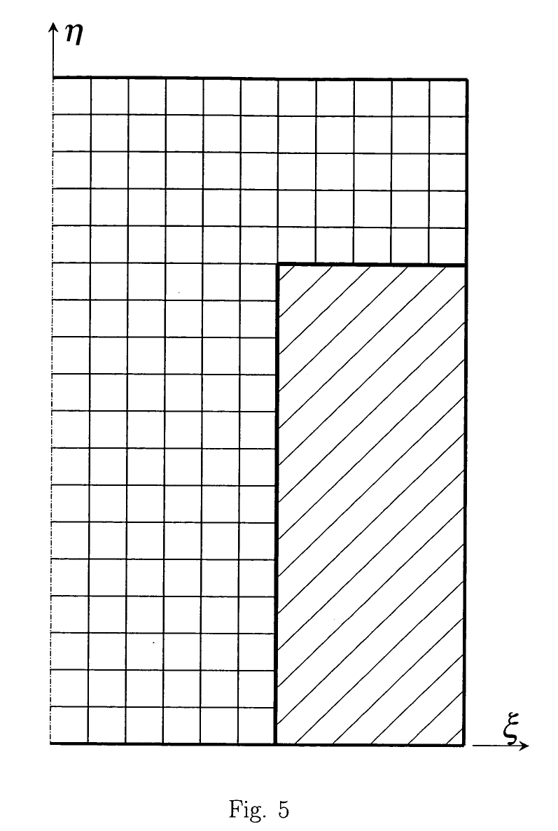

A typical quadrilateral grid in the physical space for ink-jet simulations is shown in FIG. 4. A typical rectangular grid in the computational space is shown in FIG. 5. Here, it is assumed that the grid in the computational space comprises uniform square meshes, i.e., it has uniform cells of size Δξ=Δη=1. These cells are centered at (ξᵢ=i−½, ηⱼ=j−½)

At time step tⁿ, it is assumed that the discrete velocity uⁿ=(u_{i,j}, v_{i,j}), pressure p_{i,j}ⁿ, and level set φ_{i,j} at cell centers. The purpose is to obtain the velocity, pressure and level set at t=tⁿ⁺¹, that is, to obtain u_{i+1/2,j+1/2}ⁿ⁺¹, p_{i+1/2,j+1/2}ⁿ⁺¹, and φ_{i+1/2,j+1/2}ⁿ⁺¹.

B.1. Interpolation

The first stage is to linearly reconstruct the field, in the computational space, from the discrete velocity and level set values at cell centers, according to equations (24). In these equations, u_{i,j}′ and u_{i,j}(φ_{i,j}′ and φ_{i,j}) are the discrete velocity (level set) slopes in the ξ and η directions, respectively. There are several ways to calculate these slopes. For example, one can employ the second-order monotonicity-limited slopes as was discussed in equations (60)-(62) in the above-identified related application 2. Alternatively, as is preferred here, these slopes are calculated using the simple central differences set forth in equations (25).

B.2. Predictor

The second stage is to obtain the velocity and level set predictors at t=t^{n+1/2} This can be easily done by Taylor's expansion in time, as per the equations in (26). The time derivatives on the right hand side of (26) are evaluated by substituting equations (15), which results in the equations in (27). After the level set predictor φ_{i,j}^{n+1/2} at cell centers is obtained, the time-centered densities (ρ(φ^{n+1/2})) and viscosities (μ(φ^{n+1/2})) are calculated using equation (23). Note that these densities and viscosities are still cell-centered at t=t^{n+1/2}.

To implement the predictors in (27), the interpolations in equations (24) and (25) are used extensively. For example, to calculate the last term in the second of the two equations in (27), there is equation (28). Using (26) for φ_{i+1/2,j}ⁿ, (29) is obtained. Calculations for other edge level sets and velocities are the same. The edge velocity fluxes are calculated according to the equations in (30).

B.3. Corrector

The third stage is to evolve the piecewise linear approximants (24) at tⁿ to tⁿ⁺¹. The new velocity field and level set are first realized by their staggered cell averages as set forth in equations (31), where A_{i+1/2,j+1/2} is the volume of staggered cell C_{i+1/2,j+1/2} and is given by equation (32). The central difference nature of the scheme is strongly linked to the staggered averages in (31), which should be integrated in the control box C_{i+1/2,j+1/2}×[tⁿ,tⁿ⁺¹]. Taking the level set convection equation as an example, substitute equation (33) into the first equation in (31) to yield equation (34). For the first term on the right hand side of equation (34), plug in the linearly reconstructed level set (i.e., the second equation in (24)). For the second and third terms, use the mid-point quadrature in space and time. Taking the second term as an example, the substitution is shown in equation (35), where the time-centered quantities are those velocity and level set predictors obtained in the previous stage, and the derivative operator D_{ξ}⁺ and average operator μ_{η}⁺ are defined as shown in equations (36). In the following, I use similarly defined derivative and average operators such as D_{η}⁺,D_{ξ}⁻,μ_{ξ}⁺, etc.

After plugging in the linearly reconstructed field and the predictors, the staggered level set average in equation (34) becomes as shown in equation (37). Similarly, the velocity field is as set forth in equations (38) and (39), where (Viscosity)ᵣ and (Viscosity)_{z} are the r and z components of the viscosity term, which is given in (16).

Note that these level set and velocity correctors at t=tⁿ⁺¹ are located at grid points. Since the incompressibility condition has not been reinforced, the velocity field given by equations (38) and (39) is not divergence-free.

B.4. Recover the Point Value

Once the cell average ũⁿ⁺¹ is obtained, the point value needs to be recovered. This procedure is unique in axi-symmetric coordinate systems because each cell has a different r factor. Equation (40) is used to recover the point values.

B.5. Projection for uⁿ⁺¹

The velocity field uⁿ⁺¹ at t=tⁿ⁺¹ set forth in equation (41) is incompressible. If the divergence operator is applied on both sides of (41) and it is noted that ∇·uⁿ⁺¹=0, the result in equation (42) is obtained. The projection equation (42) is elliptic. It reduces to a Poisson's equation if the density ratio ρ(φ^{n+1/2}) is a constant. The finite element formulation of the projection equation shown in equation (43) can also be used in an implementation, where Γ₁ denotes all the boundaries where the inflow or outflow velocity U^{BC} is given. It can be verified by the divergence theory that the implied boundary condition at Γ₁ is as shown in equation (44). It is noticeable that the second term on the right hand side of (43) vanishes if boundary pressures are given at both the inflow and outflow.

After the pressure pⁿ⁺¹ is solved from equation (42), the velocity field uⁿ⁺¹ can be obtained by equation (41).

C. Re-initialization of the Level Set

To correctly capture the interface and accurately calculate the surface tension, the level set needs to be maintained as a signed distance function to the interface. However, if the level set is updated by the third equation in (15), it will not remain as such. Therefore, instead, the simulation is periodically stopped and a new level set function φ is recreated, which is the signed distance function, i.e., |∇φ|=1, without changing the zero level set of the original level set function.

The need to do so in level set calculations has been previously recognized, as has re-initialization. A direct and simple method for re-initialization is to first find the interface (the zero level set) using a contour plotter and then recalculate the signed distance from each cell to the interface. Another simple re-initialization choice is to solve the crossing time problem as set forth in equation (45), where F is a given normal velocity. It is noticeable that t′ has been used in equation (45) to emphasize that it is a pseudo time variable and the equation is solved solely for the purpose of re-initialization. With F=1, flow the interface forward and backward in time and calculate the time t′ at which the level set function changes sign for each cell. The crossing times (both positive and negative) are equal to the signed distances. Either of these two simple methods is suitable for use with the present invention. Both have been tried with no noticeable difference in simulation results.

An even better re-initialization scheme for use in this invention is described in application Ser. No. 10/729,637, filed on Dec. 5, 2003 and entitled “Selectively Reduced Bi-cubic Interpolation for Ink-Jet Simulations on Quadrilateral Grids” is used. The disclosure of this application is incorporated herein by reference. This re-initialization scheme exhibits much better mass conservation performance.

D. Nature of Staggering

According to the previous subsections, the central difference scheme first integrates the Navier-Stokes equations without the continuity condition. At t=tⁿ the velocity and level set are located at cell centers while the pressure is at grid points. The time-centered velocity and level set predictors are first calculated using the Taylor's expansion in time. The time-centered density predictor is calculated using the time-centered level set. These predictors, which are located at cell centers, are then used to calculate the velocity and level set correctors at grid points. Since we want the relative position between the pressure and velocity to remain the same, the velocity uⁿ⁺¹ obtained in the projection step is located at grid points and the pressure pⁿ⁺¹ at cell centers.

The situation from t=tⁿ⁺¹ to t=tⁿ⁺² is the other way around. At t=tⁿ⁺¹ the velocity is located at grid points and the pressure at cell centers. The central difference scheme first calculates the time-centered velocity and level set predictors at grid points. These predictors are then used to obtain the correctors at cell centers. After the projection is done, the incompressible velocity uⁿ⁺² is located at cell centers and the pressure pⁿ⁺² at grid points. Since the location of the discrete velocity and pressure in our numerical scheme changes every time step, it has what is referred to as a “nature of staggering.”

E. Multi-Grid-Compatiable Projections

To improve the performance of the central algorithm on quadrilateral grids, the employment of multi-grid-compatible projection operators, as is disclosed in the related application 1, is necessary. A finite difference projection operator is used when the velocity corrector is located at grid points and the pressure at cell centers. A finite element projection operator is used when the velocity corrector is located at cell centers and the pressure at grid points. When the finite difference projection is adopted, the cell density is lagged in time by one half time step, referred to as “retarded” density. Since the finite element projection operator can easily be discretized on any mesh, rectangular, quadrilateral, or triangular, we only explain how to discretize the projection when a finite difference operator is needed. In computational space, projection equation (42) assumes the form given in (46). Applying the central difference, (46) can be discretized like (47), where terms in the right hand side are defined in (48). The terms in the left hand side of (47) can be easily obtained by averaging like (49). The pressure gradients in (48) can be easily got by central differencing in the computational space.

F. Constraint on Time Step

Since the time integration scheme is explicit Euler, the time step constraint is determined by the CFL condition, surface tension, viscosity, and total acceleration, as shown in equation (50), where h=min(Δr, Δz) and Fⁿ is defined in (51).

G. Flow Chart

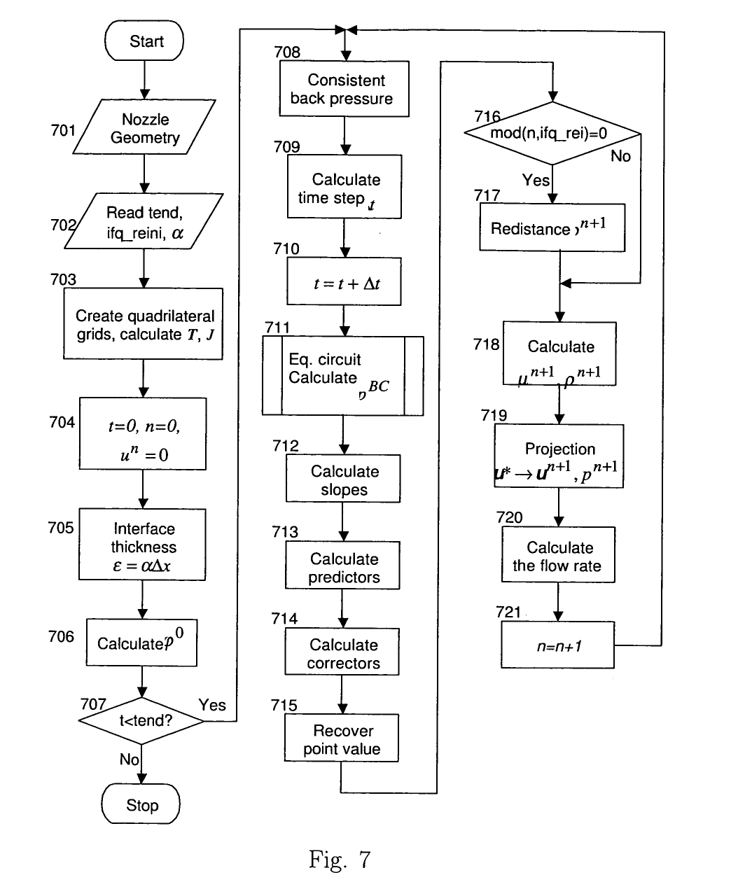

As shown by the flowchart in FIG. 7, the algorithm is basically sequential. The code first reads the nozzle geometry (step 701) and also reads control parameters like tend (end time of the simulation), α (the extent of interface smearing), ifq_reini (how often the level set should be re-initialized) (step 702). With the given nozzle geometry, the code creates a quadrilateral grid, and calculates the transformation matrix T and Jacobian J according to equations (12) (step 703). The time and the number of the current time step are set to zero and the initial fluid velocity is set to zero everywhere (step 704). With the given smearing parameter (α), the interface thickness is set using equation (22) (step 705). The level set is then initialized by assuming that the initial ink-air interface is flat (step 706).

Now the time loop starts by checking whether t<tend (step 307). If so, the consistent back pressure is determined following the procedure in application Ser. No. 10/652,386, filed on Aug. 29, 2003 and entitled “Consistent Back Pressure for Piezoelectric Ink-Jet Simulation,” the disclosure of which is incorporated by reference herein (step 708). The time step is then determined by equations (50) and (51) to ensure the stability of the code (step 709). The time is updated (step 710). The time step and the ink flow rate (the initial flow rate is zero) are then passed to an equivalent circuit or like analytic tool, which calculates the inflow pressure for the current time step (step 711). After receiving the inflow pressure from the equivalent circuit, the CFD code proceeds to solve the partial differential equations. The slopes of velocities and level set are first calculated following equation (25) (step 712). The predictors are then calculated using equations (27) (step 713). The time-centered viscosity and density are also calculated once the level set predictor is obtained. The velocity and level set correctors are calculated by the use of equations (31) to (39) (step 714). The point values of the velocity and level set are recovered using equations (40) (step 715). For every ifq_reini time steps, the level set is also re-distanced (steps 716 and 717). The new fluid viscosity and density are calculated using the new level set values (step 718). The velocity field is projected into the divergence-free space to get the new pressure and incompressible velocity fields (step 719). The last things to do in the loop are calculating the ink flow rate (step 720) and updating the number of the time step (step 721).

IV. Applications and Effects

As the foregoing demonstrates, the present invention provides a central difference scheme for the coupled level set projection method for two-phase ink-jet simulations for quadrilateral grids on axi-symmetric coordinate systems.

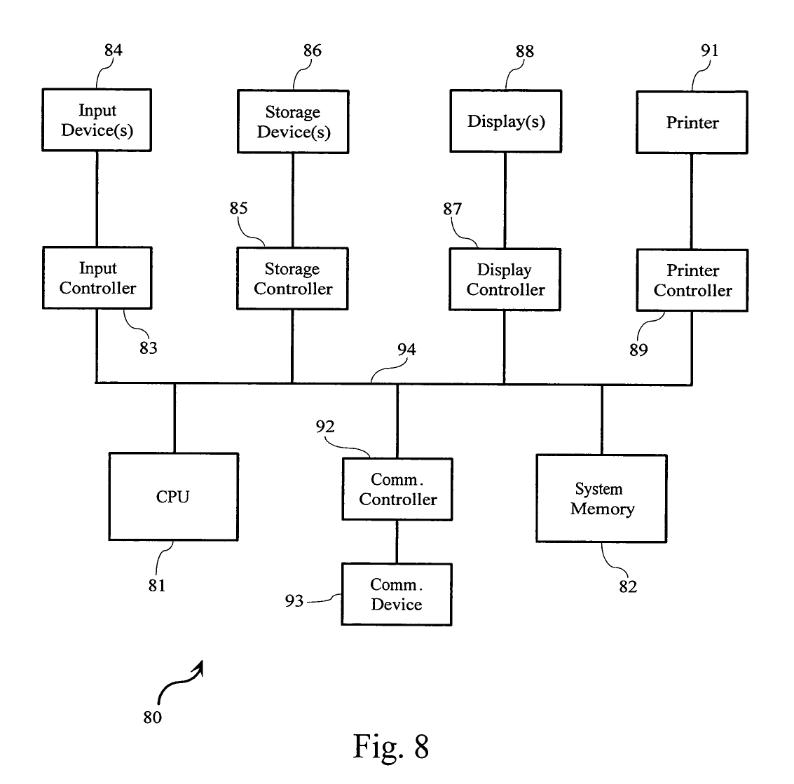

Having described the details of the invention, an exemplary system 80 which may be used to implement one or more aspects of the present invention will now be described with reference to FIG. 8. As illustrated in FIG. 8, the system, which may be an XP Windows workstation, includes a central processing unit (CPU) 81 that provides computing resources and controls the computer. CPU 81 may be implemented with a microprocessor or the like, and may represent more than one CPU (e.g., dual Xeon 2.8 GHz CPUs), and may also include one or more auxiliary chips such as a graphics processor. System 80 further includes system memory 82, which may be in the form of random-access memory (RAM) and read-only memory (ROM).

A number of controllers and peripheral devices are also provided, as shown in FIG. 8. Input controller 83 represents an interface to various input devices 84, such as a keyboard, mouse or stylus. A storage controller 85 interfaces with one or more storage devices 86 each of which includes a storage medium such as magnetic tape or disk, or an optical medium that may be used to record programs of instructions for operating systems, utilities and applications which may include embodiments of programs that implement various aspects of the present invention. Storage device(s) 86 may also be used to store processed or data to be processed in accordance with the invention. A display controller 87 provides an interface to a display device 88, which may be any know type, for viewing the simulation. A printer controller 89 is also provided for communicating with a printer 91. A communications controller 92 interfaces with one or more communication devices 93 that enables system 80 to connect to remote devices through any of a variety of networks including the Internet, a local area network (LAN), a wide area network (WAN), or through any suitable electromagnetic carrier signals including infrared signals.

In the illustrated system, all major system components connect to bus 94 which may represent more than one physical bus. However, various system components may or may not be in physical proximity to one another. For example, input data and/or output data may be remotely transmitted from one physical location to another. Also, programs that implement various aspects of this invention may be accessed from a remote location (e.g., a server) over a network. Such data and/or programs may be conveyed through any of a variety of machine-readable medium including magnetic tape or disk or optical disc, network signals, or any other suitable electromagnetic carrier signals including infrared signals.

The present invention may be conveniently implemented with software. However, alternative implementations are certainly possible, including a hardware and/or a software/hardware implementation. Hardware-implemented functions may be realized using ASIC(s), digital signal processing circuitry, or the like. Accordingly, the phrase “components or modules” in the claims is intended to cover both software and hardware implementations. Similarly, the term “machine-readable medium” as used herein includes software, hardware having a program of instructions hardwired thereon, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

While the invention has been described in conjunction with several specific embodiments, further alternatives, modifications, variations and applications will be apparent to those skilled in the art in light of the foregoing description. Thus, the invention described herein is intended to embrace all such alternatives, modifications, variations and applications as may fall within the spirit and scope of the appended claims.

### APPENDIX

$$\begin{matrix}∇ \cdot u = 0 , & ( 1 ) \\ ρ ( ϕ ) [ \frac{\partial u}{\partial t} + ∇ \cdot ( uu ) ] = - ∇ p + ∇ \cdot ( 2 μ ( ϕ ) 𝒟 ) - σκ ( ϕ ) δ ( ϕ ) ∇ ϕ . & ( 2 ) \\ 𝒟 = \frac{1}{2} [ ∇ u + {( ∇ u )}^{T} ] , \\ u = u {e}_{1} + υ {e}_{2} , & ( 3 ) \\ ϕ ( x , y , t ) \{ \begin{matrix}< 0 & if & ( x , y ) ∈ fluid \#2 ( air ) \\ = 0 & if & ( x , y ) ∈ interface \\ > 0 & if & ( x , y ) ∈ fluid \#1 ( ink )\end{matrix} . & ( 4 ) \\ {{n = \frac{∇ ϕ}{\vert ∇ ϕ \vert} \vert}_{ϕ = 0} , \\ κ = ∇ \cdot ( \frac{∇ ϕ}{\vert ∇ ϕ \vert} ) \vert}_{ϕ = 0} . & ( 5 ) \\ x = {Lx}^{′} , \\ y = {Ly}^{′} , \\ u = {Uu}^{′} , \\ t = \frac{L}{U} {t}^{′} , \\ p = {ρ}_{1} {U}^{2} {p}^{′} , \\ ρ = {ρ}_{1} {ρ}^{′} , \\ μ = {μ}_{1} {μ}^{′} , & ( 6 ) \\ ∇ \cdot u = 0 , & ( 7 ) \\ \frac{\partial u}{\partial t} + ∇ \cdot ( uu ) = - \frac{1}{ρ ( ϕ )} ∇ p + \frac{1}{ρ ( ϕ ) R e} ∇ \cdot ( 2 μ ( ϕ ) 𝒟 ) - \frac{1}{ρ ( ϕ ) W e} κ ( ϕ ) δ ( ϕ ) ∇ ϕ , & ( 8 ) \\ ρ ( ϕ ) = \{ \begin{matrix}1 & if ϕ \geq 0 \\ {ρ}_{2} / {ρ}_{1} & if ϕ < 0\end{matrix} , \\ μ ( ϕ ) = \{ \begin{matrix}1 & if ϕ \geq 0 \\ {μ}_{2} / {μ}_{1} & if ϕ < 0\end{matrix} , \\ R e = \frac{{ρ}_{1} UL}{{μ}_{1}} , \\ W e = \frac{{ρ}_{1} {U}^{2} L}{σ} . & ( 9 ) \\ \frac{\partial ϕ}{\partial t} + ∇ \cdot ( u ϕ ) = 0. & ( 10 ) \\ X = Φ ( Ξ ) . & ( 11 ) \\ J = g det {∇}_{Ξ} Φ = g det ( \begin{matrix}{r}_{ξ} & {r}_{η} \\ {z}_{ξ} & {z}_{η}\end{matrix} ) , \\ T = {g}^{- 1} {J [ {∇}_{Ξ} Φ ]}^{- 1} = ( \begin{matrix}{z}_{η} & - {r}_{η} \\ - {z}_{ξ} & {r}_{ξ}\end{matrix} ) , & ( 12 ) \\ \overline{u} = g T u . & ( 13 ) \\ r -> x , \\ z -> y , \\ g -> 1. & ( 14 ) \\ \frac{\partial u}{\partial t} + {J}^{- 1} {∇}_{Ξ} \cdot ( \overline{u} u ) = - \frac{1}{ρ ( ϕ ) J} g {T}^{T} {∇}_{Ξ} p + ( Viscosity term ) - \frac{g δ ( ϕ )}{{J}^{2} ρ ( ϕ ) W e} {∇}_{Ξ} \cdot ( g T \frac{{T}^{T} {∇}_{Ξ} ϕ}{\vert {T}^{T} {∇}_{Ξ} ϕ \vert} ) ( {T}^{T} {∇}_{Ξ} ϕ ) , \\ {∇}_{Ξ} \cdot \overline{u} = 0 , \\ \frac{\partial ϕ}{\partial t} + {J}^{- 1} {∇}_{Ξ} \cdot ( \overline{u} ϕ ) = 0 , & ( 15 ) \\ \frac{1}{ρ ( ϕ ) R e} ∇ \cdot [ 2 μ ( ϕ ) 𝒟 ] = \frac{g}{J ρ ( ϕ ) R e} \{ {T}^{T} {∇}_{Ξ} μ ( ϕ ) ] \cdot [ g {J}^{- 1} {T}^{T} {∇}_{Ξ} u + {( g {J}^{- 1} {T}^{T} {∇}_{Ξ} u )}^{T} ] + \frac{μ ( ϕ )}{J ρ ( ϕ ) R e} {∇}_{Ξ} \cdot \{ {g}^{2} {J}^{- 1} T {T}^{T} {∇}_{Ξ} u \} + \frac{μ ( ϕ )}{ρ ( ϕ ) R e} ( \begin{matrix}- \frac{u}{{r}^{2}} \\ 0\end{matrix} ) . & ( 16 ) \\ u = {u}^{BC} , & ( 17 ) \\ p = {p}^{BC} , \\ \frac{\partial u}{\partial n} = 0 , & ( 18 ) \\ {u}^{n} = u ( t = {t}^{n} ) & ( 19 ) \\ H ( ϕ ) = \{ \begin{matrix}0 & if ϕ < - ε \\ \frac{1}{2} [ 1 + \frac{ϕ}{ε} + \frac{1}{π} sin ( πϕ / ε ) ] & if \vert ϕ \vert \leq ε \\ 1 & if ϕ > ε .\end{matrix} & ( 20 ) \\ δ ( ϕ ) = \frac{ⅆ H ( ϕ )}{ⅆ ϕ} . & ( 21 ) \\ ε = αΔ x , & ( 22 ) \\ ρ ( ϕ ) = \frac{{ρ}_{2}}{{ρ}_{1}} + H ( ϕ ) ( 1 - \frac{{ρ}_{2}}{{ρ}_{1}} ) , \\ μ ( ϕ ) = \frac{{μ}_{2}}{{μ}_{1}} + H ( ϕ ) ( 1 - \frac{{μ}_{2}}{{μ}_{1}} ) . & ( 23 ) \\ {u}^{n} ( ξ , η ) = {u}_{i , j}^{n} + {u}_{i , j}^{′} ( ξ - {ξ}_{i} ) + {u}_{i , j}^{′} ( η - {η}_{j} ) , \\ {ϕ}^{n} ( ξ , η ) = {ϕ}_{i , j}^{n} + {ϕ}_{i , j}^{′} ( ξ - {ξ}_{i} ) + {ϕ}_{i , j}^{′} ( η - {η}_{j} ) . & ( 24 ) \\ {u}_{i , j}^{′} = \frac{{u}_{i + 1 , j}^{n} - {u}_{i - 1 , j}^{n}}{2} , \\ {u}_{i , j}^{′} = \frac{{u}_{i , j + 1}^{n} - {u}_{i , j - 1}^{n}}{2} , \\ {ϕ}_{i , j}^{′} = \frac{{ϕ}_{i + 1 , j}^{n} - {ϕ}_{i - 1 , j}^{n}}{2} , \\ {ϕ}_{i , j}^{′} = \frac{{ϕ}_{i , j + 1}^{n} - {ϕ}_{i , j - 1}^{n}}{2} . & ( 25 ) \\ {{{u}_{i , j}^{n + 1 / 2} = {u}_{i , j}^{n} + \frac{Δ t}{2} \frac{\partial u}{\partial t} \vert}_{t = {t}^{n}} , \\ {ϕ}_{i , j}^{n + 1 / 2} = {ϕ}_{i , j}^{n} + \frac{Δ t}{2} \frac{\partial ϕ}{\partial t} \vert}_{t = {t}^{n}} . & ( 26 ) \\ {u}_{i , j}^{n + 1 / 2} = {u}_{i , j}^{n} + \frac{Δ t}{2} {\{ \begin{matrix}- {J}^{- 1} {∇}_{Ξ} \cdot ( \overline{u} u ) - \frac{1}{ρ ( ϕ ) J} g {T}^{T} {∇}_{Ξ} p + \\ ( Viscosity term ) - \frac{g δ ( ϕ )}{{J}^{2} ρ ( ϕ ) W e} {∇}_{Ξ} \cdot \\ ( g T \frac{{T}^{T} {∇}_{Ξ} ϕ}{\vert {T}^{T} {∇}_{Ξ} ϕ \vert} ) ( {T}^{T} {∇}_{Ξ} ϕ ) - \frac{1}{Fr} {e}_{z}\end{matrix} \}}_{i , j}^{n} , \\ {ϕ}_{i , j}^{n + 1 / 2} = {ϕ}_{i , j}^{n} - \frac{Δ t}{2} {\{ {J}^{- 1} {∇}_{Ξ} \cdot ( \overline{u} ϕ ) \}}_{i , j}^{n} . & ( 27 ) \\ {\{ {∇}_{Ξ} \cdot ( \overline{u} ϕ ) \}}_{i , j}^{n} = {\overline{u}}_{i + 1 / 2 , j}^{n} {ϕ}_{i + 1 / 2 , j}^{n} - {\overline{u}}_{i - 1 / 2 , j}^{n} {ϕ}_{i - 1 / 2 , j}^{n} + {\overline{υ}}_{i , j + 1 / 2}^{n} {ϕ}_{i , j + 1 / 2}^{n} - {\overline{υ}}_{i , j - 1 / 2}^{n} {ϕ}_{i , j - 1 / 2}^{n} . & ( 28 ) \\ \begin{matrix}{ϕ}_{i + 1 / 2 , j}^{n} = {ϕ}^{n} ( {ξ}_{i + 1 / 2 , j} , {η}_{i + 1 / 2 , j} ) \\ = {ϕ}_{i , j}^{n} + {ϕ}_{i , j}^{′} ( {ξ}_{i + 1 / 2 , j} - {ξ}_{i , j} ) + {ϕ}_{i , j}^{′} ( {η}_{i + 1 / 2 , j} - {η}_{i , j} ) \\ = {ϕ}_{i , j}^{n} + \frac{1}{2} {ϕ}_{i , j}^{′} .\end{matrix} & ( 29 ) \\ {( {\overline{u}}_{i + 1 / 2 , j}^{n} , {\overline{υ}}_{i + 1 / 2 , j}^{n} )}^{T} = {( g T )}_{i + 1 / 2 , j} {( {u}_{i + 1 / 2 , j}^{n} , {υ}_{i + 1 / 2 , j}^{n} )}^{T} , \\ {( {\overline{u}}_{i , j + 1 / 2}^{n} , {\overline{υ}}_{i , j + 1 / 2}^{n} )}^{T} = {( g T )}_{i , j + 1 / 2} {( {u}_{i , j + 1 / 2}^{n} {υ}_{i , j + 1 / 2}^{n} )}^{T} . & ( 30 ) \\ {\tilde{ϕ}}_{i + 1 / 2 , j + 1 / 2}^{n + 1} = \frac{1}{{𝒜}_{i + 1 / 2 , j + 1 / 2}} {\int }_{{C}_{i + 1 / 2 , j + 1 / 2}} ϕ ( r , z , {t}^{n + 1} ) 2 π r ⅆ r ⅆ z , \\ {\tilde{u}}_{i + 1 / 2 , j + 1 / 2}^{n + 1} = \frac{1}{{𝒜}_{i + 1 / 2 , j + 1 / 2}} {\int }_{{C}_{i + 1 / 2 , j + 1 / 2}} u ( r , z , {t}^{n + 1} ) 2 π r ⅆ r ⅆ z , & ( 31 ) \\ {𝒜}_{i + 1 / 2 , j + 1 / 2} = {\int }_{{C}_{i + 1 / 2 , j + 1 / 2}} 2 π r ⅆ r ⅆ z . & ( 32 ) \\ ϕ = {ϕ}^{n} - \int ∇ \cdot ( u ϕ ) ⅆ t = {ϕ}^{n} - \int {J}^{- 1} {∇}_{Ξ} \cdot ( \overline{u} ϕ ) ⅆ t & ( 33 ) \\ {\tilde{ϕ}}_{i + 1 / 2 , j + 1 / 2}^{n + 1} = \frac{1}{{𝒜}_{i + 1 / 2 , j + 1 / 2}} \{ {\int }_{{C}_{i + 1 / 2 , j + 1 / 2}} ϕ ( x , y , {t}^{n} ) J ⅆ ξ ⅆ η - {D}_{ξ}^{+} {\int }_{τ = {t}^{n}}^{{t}^{n + 1}} {\int }_{η ∈ {J}_{j + 1 / 2}} ( \overline{u} ϕ ) ⅆ η ⅆ τ - {D}_{η}^{+} {\int }_{τ = {t}^{n}}^{{t}^{n + 1}} {\int }_{ξ ∈ {I}_{i + 1 / 2}} ( \overline{υ} ϕ ) ⅆ ξ ⅆ τ \} . & ( 34 ) \\ \frac{1}{{𝒜}_{i + 1 / 2 , j + 1 / 2}} {D}_{ξ}^{+} {\int }_{τ = {t}^{n}}^{{t}^{n + 1}} {\int }_{η ∈ {J}_{j + 1 / 2}} ( \overline{u} ϕ ) ⅆ η ⅆ τ = \frac{Δ t}{{𝒜}_{i + 1 / 2 , j + 1 / 2}} [ {D}_{ξ}^{+} {μ}_{η}^{+} ( {\overline{u}}_{i , j}^{n + 1 / 2} {ϕ}_{i , j}^{n + 1 / 2} ) ] , & ( 35 ) \\ {D}_{ξ}^{+} {\overline{u}}_{i , j} = {\overline{u}}_{i + 1 , j} - {\overline{u}}_{i , j} , \\ {μ}_{η}^{+} {\overline{u}}_{i , j} = \frac{{\overline{u}}_{i , j + 1} + {\overline{u}}_{i , j}}{2} . & ( 36 ) \\ {\tilde{ϕ}}_{i + 1 / 2 , j + 1 / 2}^{n + 1} = \frac{{μ}_{ξ}^{+} {μ}_{η}^{+}}{{𝒜}_{i + 1 / 2 , j + 1 / 2}} ( {J}_{i , j} {ϕ}_{i , j}^{n} ) - \frac{1}{8} {D}_{ξ}^{+} {μ}_{η}^{+} {ϕ}_{i , j}^{′} - \frac{1}{8} {D}_{η}^{+} {μ}_{ξ}^{+} {ϕ}_{i , j}^{′} - Δ t [ {D}_{ξ}^{+} {μ}_{η}^{+} ( {\overline{u}}_{i , j}^{n + 1 / 2} {ϕ}_{i , j}^{n + 1 / 2} ) + {D}_{η}^{+} {μ}_{ξ}^{+} ( {\overline{υ}}_{i , j}^{n + 1 / 2} {ϕ}_{i , j}^{n + 1 / 2} ) ] . & ( 37 ) \\ \begin{matrix}{\overline{u}}_{i + 1 / 2 , j + 1 / 2}^{n + 1} = \frac{1}{{𝒜}_{i + 1 / 2 , j + 1 / 2}} \{ {\int }_{{C}_{i + 1 / 2 , j + 1 / 2}} u ( x , y , {t}^{n} ) J ⅆ ξ ⅆ η - \\ {D}_{ξ}^{+} {\int }_{τ = {t}^{n}}^{{t}^{n + 1}} {\int }_{η ∈ {J}_{j + 1 / 2}} \overline{u} u ⅆ η ⅆ τ - \\ {D}_{η}^{+} {\int }_{τ = {t}^{n}}^{{t}^{n + 1}} {\int }_{ξ ∈ {I}_{i + 1 / 2}} \overline{υ} u ⅆ ξ ⅆ τ + \\ {D}_{η}^{+} {\int }_{τ = {t}^{n}}^{{t}^{n + 1}} {\int }_{ξ ∈ {I}_{i + 1 / 2}} \overline{υ} u ⅆ ξ ⅆ τ + \\ {\int }_{τ = {t}^{n}}^{{t}^{n + 1}} {\int }_{{C}_{i + 1 / 2 , j + 1 / 2}} {( Viscosity )}_{r} ⅆ ξ ⅆ η ⅆ τ - \\ {\int }_{τ - {t}^{n}}^{{t}^{n + 1}} {\int }_{{C}_{i + 1 / 2 , j + 1 / 22}} \frac{1}{ρ ( ϕ ) W e} κ ( ϕ ) δ ( ϕ ) ϕ {,}_{x} ⅆ ξ ⅆ η ⅆ τ \} \\ = \frac{{μ}_{ξ}^{+} {μ}_{η}^{+}}{{𝒜}_{i + 1 / 2 , j + 1 / 2}} ( {J}_{i , j} {u}_{i , j}^{n} ) - \frac{1}{8} {D}_{ξ}^{+} {μ}_{η}^{+} {u}_{i , j}^{′} - \frac{1}{8} {D}_{η}^{+} {μ}_{ξ}^{+} {u}_{i , j}^{′} - \\ Δ t [ {D}_{ξ}^{+} {μ}_{η}^{+} ( {\overline{u}}_{i , j}^{n + 1 / 2} {u}_{i , j}^{n + 1 / 2} ) + {D}_{η}^{+} {μ}_{ξ}^{+} ( {\overline{υ}}_{i , j}^{n + 1 / 2} {u}_{i , j}^{n + 1 / 2} ) ] + \\ Δ t {μ}_{x}^{+} {{μ}_{y}^{+} ( Viscosity )}_{r , i , j}^{n + 1 / 2} - \\ Δ t {μ}_{ξ}^{+} {μ}_{η}^{+} {\{ \begin{matrix}\frac{g δ ( ϕ )}{J ρ ( ϕ ) W e} {∇}_{Ξ} \cdot \\ ( g T \frac{{T}^{T} {∇}_{Ξ} ϕ}{\vert {T}^{T} {∇}_{Ξ} ϕ \vert} ) ( {z}_{, η} {ϕ}_{, ξ} - {z}_{, ξ} {ϕ}_{, η} )\end{matrix} \}}_{i , j}^{n + 1 / 2} ,\end{matrix} & ( 38 ) \\ \begin{matrix}{\tilde{υ}}_{i + 1 / 2 , j + 1 / 2}^{n + 1} = \frac{1}{{𝒜}_{i + 1 / 2 , j + 1 / 2}} \{ {\int }_{{C}_{i + 1 / 2 , j + 1 / 2}} υ ( x , y , {t}^{n} ) J ⅆ ξ ⅆ η - \\ {D}_{ξ}^{+} {\int }_{τ = {t}^{n}}^{{t}^{n + 1}} {\int }_{η ∈ {J}_{j + 1 / 2}} \overline{u} υ ⅆ η ⅆ τ - \\ {D}_{η}^{+} {\int }_{τ = {t}^{n}}^{{t}^{n + 1}} {\int }_{ξ ∈ {I}_{i + 1 / 2}} \overline{υ} υ ⅆ ξ ⅆ τ + \\ {\int }_{τ = {t}^{n}}^{{t}^{n + 1}} {\int }_{{C}_{i + 1 / 2 , j + 1 / 2}} {( Viscosity )}_{r} ⅆ ξ ⅆ η ⅆ τ - \\ {\int }_{τ = {t}^{n}}^{{t}^{n + 1}} {\int }_{{C}_{i + 1 / 2 , j + 1 / 2}} \frac{1}{ρ ( ϕ ) W e} κ ( ϕ ) δ ( ϕ ) {ϕ}_{, y} ⅆ ξ ⅆ η ⅆ τ \\ = \frac{{μ}_{ξ}^{+} {μ}_{η}^{+}}{{𝒜}_{i + 1 / 2 , j + 1 / 2}} ( {J}_{i , j} {υ}_{i , j}^{n} ) - \frac{1}{8} {D}_{ξ}^{+} {μ}_{η}^{+} {υ}_{i , j}^{′} - \frac{1}{8} {D}_{η}^{+} {μ}_{ξ}^{+} {υ}_{i , j}^{′} - \\ Δ t [ {D}_{ξ}^{+} {μ}_{η}^{+} ( {\overline{u}}_{i , j}^{n + 1 / 2} {υ}_{i , j}^{n + 1 / 2} ) + {D}_{η}^{+} {μ}_{ξ}^{+} ( {\overline{υ}}_{i , j}^{n + 1 / 2} {υ}_{i , j}^{n + 1 / 2} ) ] + \\ Δ t {μ}_{x}^{+} {{μ}_{y}^{+} ( Viscosity )}_{z , i , j}^{n + 1 / 2} - \\ Δ t {μ}_{ξ}^{+} {μ}_{η}^{+} {\{ \begin{matrix}\frac{g δ ( ϕ )}{J ρ ( ϕ ) W e} {∇}_{Ξ} \cdot \\ ( g T \frac{{T}^{T} {∇}_{Ξ} ϕ}{\vert {T}^{T} {∇}_{Ξ} ϕ \vert} ) ( - {r}_{, η} {ϕ}_{, ξ} + {r}_{, ξ} {ϕ}_{, η} )\end{matrix} \}}_{i , j}^{n + 1 / 2} ,\end{matrix} & ( 39 ) \\ {u}_{i + 1 / 2 , j + 1 / 2}^{*} = {\tilde{u}}_{i + 1 / 2 , j + 1 / 2}^{n + 1} - \frac{Δ {r}^{2}}{12 {r}_{i + 1 / 2}} {D}_{r}^{0} {\tilde{u}}_{i + 1 / 2 , j + 1 / 2}^{n + 1} & ( 40 ) \\ {u}^{n + 1} = {u}^{*} \frac{- 1}{{ρ}^{n + 1 / 2}} ∇ ϕ & ( 41 ) \\ ∇ \cdot {u}^{*} = ∇ \cdot ( \frac{Δ t}{ρ ( {ϕ}^{n + 1 / 2} )} ∇ {p}^{n + 1} ) . & ( 42 ) \\ {\int }_{Ω} {u}^{*} \cdot ∇ ψ ⅆ x = {\int }_{Ω} \frac{Δ t}{ρ ( {ϕ}^{n + 1 / 2} )} ∇ {p}^{ n + 1} \cdot ∇ ψ ⅆ x + {\int }_{{Γ}_{1}} ψ {u}^{BC} \cdot n ⅆ S , & ( 43 ) \\ \frac{Δ t}{ρ ( {ϕ}^{n + 1 / 2} )} \frac{\partial {p}^{n + 1}}{\partial n} = ( {u}^{*} - {u}^{BC} ) \cdot n . & ( 44 ) \\ {ϕ}_{{t}^{′}} + F \vert ϕ \vert = 0 , & ( 45 ) \\ {∇}_{Ξ} \cdot {\overline{u}}^{*} = {∇}_{Ξ} \cdot ( \frac{g Δ t}{J ρ ( {ϕ}^{n + 1 / 2} )} T {T}^{T} {∇}_{Ξ} {p}^{n + 1} ) . & ( 46 ) \\ {\overline{u}}_{i + 1 / 2 , j}^{*} - {\overline{u}}_{i - 1 / 2 , j}^{*} + {\overline{υ}}_{i , j + 1 / 2}^{*} - {\overline{υ}}_{i , j - 1 / 2}^{*} = {ℳ}_{i + 1 / 2 , j} - {ℳ}_{i - 1 / 2 , j} + {𝒩}_{i , j + 1 / 2} - {𝒩}_{i , j - 1 / 22} , & ( 47 ) \\ {ℳ}_{i + 1 / 2 , j} = the first component of {( \frac{g Δ t}{J ρ ( {ϕ}^{n + 1 / 2} )} {TT}^{T} {∇}_{Ξ} {p}^{n + 1} )}_{i + 1 / 2 , j} \\ {𝒩}_{i , j + 1 / 2} = the second component of {( \frac{g Δ t}{J ρ ( {ϕ}^{n + 1 / 2} )} {TT}^{T} {∇}_{Ξ} {p}^{n + 1} )}_{i , j + 1 / 2} . & ( 48 ) \\ {\overline{u}}_{i + 1 / 2 , j}^{*} = {( g T )}_{i + 1 / 2 , j} ( {u}_{i + 1 / 2 , j + 1 / 2}^{*} + {u}_{i + 1 / 2 , j - 1 / 2}^{*} ) . & ( 49 ) \\ Δ t < {min}_{i , j} [ \frac{Δ r}{u} , \frac{Δ z}{υ} , \sqrt{W e \frac{{ρ}_{1} + {ρ}_{2}}{8 π}} {h}^{3 / 2} , \frac{R e}{2} \frac{{ρ}^{n}}{{μ}^{n}} {( \frac{1}{Δ {r}^{2}} + \frac{1}{Δ {z}^{2}} )}^{- 1} , \sqrt{\frac{2 h}{\vert {F}^{n} \vert}} ] , & ( 50 ) \\ {F}^{n} = {\{ - \frac{g}{ρ ( ϕ ) J} {∇}_{Ξ} p + ( Viscosity term ) + ( Surface tension ) - \frac{1}{F r} {e}_{2} \}}^{n} . & ( 51 )\end{matrix}$$

What is claimed is:

1. A method for simulating and analyzing fluid ejection from a channel, there being a boundary between a first fluid that flows through the channel and a second fluid, the method comprising the steps of:
(a) transforming, for a given channel geometry, a quadrilateral grid in a physical space to a uniform rectangular grid in a computational space;
(b) formulating a central-difference-based discretization on the uniform rectangular grid in the computational space;
(c) performing finite difference analysis on the uniform rectangular grid in the computational space using the central-difference-based discretization to solve equations governing the flow of at least the first fluid through at least a portion of the channel;
(d) inverse transforming the results of the finite difference analysis back to the quadrilateral grid in the physical space; and
(e) simulating the flow of the first fluid through at least the portion of the channel, and ejection therefrom, based on the results of the finite difference analysis.

2. The method of claim 1, wherein the first fluid is ink, the second fluid is air, and the channel comprises an ink-jet nozzle that is part of a piezoelectric ink-jet head.

3. The method of claim 1, wherein, in performing step (c), a level set method is used to capture characteristics of the boundary in the channel.

4. The method of claim 1, wherein the uniform rectangular grid comprises a plurality of uniform cells, the central-difference-based discretization being formulated such that, for each uniform cell there is a velocity vector for determining velocity of the first fluid and a level set value for capturing characteristics of the boundary of the channel.

5. The method of claim 4, wherein, for each uniform cell, the corresponding velocity vector and level set value are located at an approximate center of that cell at one time point and at a grid point of that cell at a next time point.

6. The method of claim 5, wherein step (b) includes constructing multi-grid compatible projection operators, including a finite difference projection operator and a finite element projection operator.

7. The method of claim 6, wherein, in step (c), finite difference analysis is performed on the uniform rectangular grid in the computational space using the central-difference-based discretization to solve equations governing the flow of at least the first fluid through at least the portion of the channel in each uniform cell at each time point, the finite difference projection operator being applied after step (c) is performed with the velocity vectors and level set values being located at the grid points and the finite element projection operator being applied after step (c) is performed with velocity vectors and level set values being located at the approximate cell centers.

8. An apparatus for simulating and analyzing fluid ejection from a channel, there being a boundary between a first fluid that flows through the channel and a second fluid, the apparatus comprising one or more components or modules configured to:
transform, for a given channel geometry, a quadrilateral grid in a physical space to a uniform rectangular grid in a computational space;
formulate a central-difference-based discretization on the uniform rectangular grid in the computational space;
perform finite difference analysis on the uniform rectangular grid in the computational space using the central-difference-based discretization to solve equations governing the flow of at least the first fluid through at least a portion of the channel;
inverse transform the results of the finite difference analysis back to the quadrilateral grid in the physical space; and
simulate the flow of the first fluid through at least the portion of the channel, and ejection therefrom, based on the results of the finite difference analysis.

9. The apparatus of claim 8, wherein the processing of the one or more components or modules is specified by a program of instructions embodied in software, hardware, or combination thereof.

10. The apparatus of claim 8, wherein the one or more components or modules comprises a display for visually observing the simulation.

11. The apparatus of claim 8, wherein the first fluid is ink, the second fluid is air, and the channel comprises an ink-jet nozzle that is part of a piezoelectric ink-jet head.

12. A machine-readable medium having a program of instructions for directing a machine to perform a method for simulating and analyzing fluid ejection from a channel, there being a boundary between a first fluid that flows through the channel and a second fluid, the program of instructions comprising:
(a) instructions for transforming, for a given channel geometry, a quadrilateral grid in a physical space to a uniform rectangular grid in a computational space;
(b) instructions for formulating a central-difference-based discretization on the uniform rectangular grid in the computational space;
(c) instructions for performing finite difference analysis on the uniform rectangular grid in the computational space using the central-difference-based discretization to solve equations governing the flow of at least the first fluid through at least a portion of the channel;
(d) instructions for inverse transforming the results of the finite difference analysis back to the quadrilateral grid in the physical space; and
(e) instructions for simulating the flow of the first fluid through at least the portion of the channel, and ejection therefrom, based on the results of the finite difference analysis.

13. The machine-readable medium of claim 12, wherein, in executing instructions (c), a level set method is used to capture characteristics of the boundary in the channel.

14. The machine-readable medium of claim 12, wherein the uniform rectangular grid comprises a plurality of uniform cells, the central-difference-based discretization being formulated such that, for each uniform cell there is a velocity vector for determining velocity of the first fluid and a level set value for capturing characteristics of the boundary in the channel.

15. The machine-readable medium of claim 14, wherein, for each uniform cell, the corresponding velocity vector and level set value are located at an approximate center of that cell at one time point and at a grid point of that cell at a next time point.

16. The machine-readable medium of claim 15, wherein instructions (b) includes instructions for constructing multi-grid compatible projection operators, including a finite difference projection operator and a finite element projection operator.

17. The machine-readable medium of claim 16, wherein, in executing instructions (c), finite difference analysis is performed on the uniform rectangular grid in the computational space using the central-difference-based discretization to solve equations governing the flow of at least the first fluid through at least the portion of the channel in each cell at each time point, the finite difference projection operator being applied after instructions (c) are executed with the velocity vectors and level set values being located at the grid points and the finite element projection operator being applied after instructions (c) are executed with velocity vectors and level set values being located at the approximate cell centers.
